(19) United States
(12) Patent Application Publication
(10) Pub. No.: US 2005/0028174 A1
(43) Pub. Date: Feb. 3, 2005

(54) Interfacing calling and callable applications

(76) Inventors: Markus L. Rossmann, Herrenberg (DE); Wolfgang Bross, Schonaich (DE); Martin Seibold, Herrenberg (DE); Fritz Oesterle, Nagold (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/633,441

(22) Filed: Jul. 31, 2003

(51) Int. Cl. G06F 3/00

(52) U.S. Cl. 719/328

(57) ABSTRACT

A computer program product includes program code which provides, when executed on a computer system, an interface between a calling application and at least one callable application. The program code represents a computer program which implements at least two controllers which cooperate with each other and are at different hierarchical levels. The controllers are instances of a generic controller. The callable application may be a transaction-tax service application.

### FIELD OF THE INVENTION

The present invention relates to computer program products and methods for interfacing a calling application and one or more callable applications.

### BACKGROUND OF THE INVENTION

Interfacing different software applications is a general problem in the field of software technology, since called applications typically require application-specific and proprietary calls and attributes (data) and respond by returning data based on an application-specific and proprietary data model.

The interfacing of different application also becomes a more and more important issue in the World Wide Web (WWW). Although the WWW has initially been user-oriented, in the sense that typically a user (“host”) interactively sends a request to a Web server and receives a response from it, which is mainly in the form of a document for immediate visual representation in the user's browser, recently the concept of “Web services” has emerged, according to which requests and responses are not (only) interactively sent and received by a human user, but rather by another program. For example, an application called PowerWarning is designed to monitor a temperature at a certain remote location and issue a power overload warning if the ambient temperature is above a certain threshold for more than a certain number of consecutive hours. The required weather information is available in a Web page from a Web server. The application obtains this Web page via the Internet every hour, extracts the pertinent temperature from it and tests whether the warning condition is fulfilled (see H: Maruyama et al.: XML and Java, Developing Web Applications Addison-Wesley, 1999, pp. 8-10). To call the Web service and extract the required information from its response, a suitable interface has to be provided, which is typically implemented as a part of the calling application. In order to facilitate the implementation of interfaces for Web services, several standards of Web services have emerged, such as XML (Extensible Markup Language), SOAP (Simple Access Object Protocol), UDDI (Universal Description, Discovery and Integration) and WSDL (Web Services Description Language).

A field in which applications typically call other applications or services is the field of business applications. Special callable applications or services (which may be, but do not have to be Web services) for which the computer program products and methods described herein may, for example, be used are transaction tax-related applications and services. The use of transaction tax-related applications and services is, however, not mandatory, and software applications relating to other fields may likewise be linked by the interfaces described herein.

Besides an income tax system which imposes income-related tax liabilities on individuals and corporations, most countries have a transaction tax system. A transaction tax liability is induced by an individual commercial transaction, such as the sale of a good, the purchase of a service or the like. Typically, the transaction tax is a certain percentage of the price of the goods or service. Normally, the transaction tax is collected by the vendor or service provider, who pays the accumulated transaction tax at certain time intervals (e.g. monthly) to a tax authority (for the sake of simplicity, the following description only mentions the purchase of goods, but is likewise directed to the provision of services etc.).

Across the world, there are mainly two different transaction tax systems: sales and use tax and value added tax (VAT). In a sales and use tax system, which is imposed in most states throughout the United States, the tax amount is derived by applying the tax rate to the retail sales price of tangible personal property or certain enumerated services. If a product is manufactured and sold in a supply chain, all transactions are non-taxable re-sales until a final retail sale to an end-user, which is taxable unless the end-user can claim an exemption from the tax. Thus, in a sales and use tax system, no tax is applied to a product until it is sold at retail. In a value added tax system, which is applied in many European countries, the transaction tax in a single individual step in a supply chain corresponds only to a percentage of the value added in this step, i.e. to the difference between the amount of money the vendor receives for the sold product and the taxable amount he had to spend in order to manufacture or provide the good. In such a value-added tax system, the amount of transaction tax accumulated over all the steps of the supply chain is independent of the number of transactions in the chain, it only depends on the price of the finished product. However, normally the “added value” is not determined in individual transactions. Rather, every vendor accumulates, on the one hand, the tax received from buyers and, on the other hand, the tax he has paid to other vendors for all the transactions occurring within certain time periods (e.g. months) and pays only the difference between these two accumulated values to the tax authority. Therefore, also in a value added tax system, when looking at an individual transaction, the buyer has to pay a certain percentage of the product's price to the vendor.

Besides these principal differences between sales-and-use tax and value-added tax, the transaction tax regulations vary from country to country, and, in the United States, from state to state even down to the level of cities and areas. For example, there are different rates in different countries and even in different states. In addition, the tax rate may depend in a particular country or state specific way on the vendor's place of business and/or the buyer's domicile and/or the origin and/or the destination of the good when it is shipped from the vendor to the buyer. In many countries there is a tax rate of zero for exported goods. However, in trade within the European Union, transaction tax has to be paid in the country where the transaction takes place, but is then credited to the destination country in a clearing procedure carried out by the tax authorities. Also the requirements for transaction tax-related bookkeeping, reporting and the form and period of tax declarations to the tax authorities generally vary from country to country.

Nowadays, big companies often have worldwide business coverage, i.e. they conduct business in far more than 100 countries with a large proportion of cross-border transactions. In view of the ever-growing internationalization and globalization of enterprises and trade, computerized systems have been designed which enable enterprises to fulfill the different transaction tax liabilities in an efficient way. There are already hundreds of different transaction-tax software solutions worldwide.

In one type of solution, a business application, such as an enterprise resource planning (ERP) application (which traditionally provides for accounting, manufacturing logistics, supply-chain management, sales-force automation, customer service and support, human resources management, etc.) also enables the user to deal with the transaction taxes. For example, the ERP product R/3 by SAP provides a facility for transaction tax calculation. In most solutions of this type, the business application and the transaction tax-related parts of the solution are closely linked to the business application provider's proprietary technology.

Another type of solution is a specialized application for transaction tax calculation and/or reporting. Examples of such applications are “TaxWare”, “Sabrix”, “Vertex” and “Datev”. Normally, each of these solutions requires its own interface, and many solutions of this type do not provide global coverage. Consequently, in practice, enterprises with worldwide coverage rely on a variety of different localized transaction-tax IT systems, which implies an effort to maintain each system individually. This leads to considerable maintenance costs and losses due to misconfiguration. In many cases, transaction tax experts need to handle a large variety of different IT systems of this kind. This often prevents them from taking the full advantage of their expertise in the optimization of transaction tax liabilities.

Further examples of transaction-tax software solutions are disclosed in U.S. Pat. No. 5,335,169 assigned to DSI, U.S. Pat. No. 5,987,429 assigned to SUN Microsystems Inc., U.S. Statutory Invention Registration No. H1,830 assigned to The Dow Chemical Company, International publication No. WO 01/16850 A2 (Applicant: Andersen Consulting, LLP), International publication No. WO 01/35678 A2 (Applicant: ESALESTAX.COM), International publication No. WO 01/41552 A2 (Applicant: Taxwear International, Inc.), International publication No. WO 01/97150 A1 (Applicant: Dryden Matrix Technologies, LLC) and Sabrix: TaxBay Architecture Guide, Version 3.0, 25 July 2001.

### SUMMARY OF THE INVENTION

The invention is directed to a computer program product including program code, when executed on a computer system, for providing an interface between a calling application and at least one callable application. The program code represents a computer program which implements at least two controllers which cooperate with each other and are at different hierarchical levels. The controllers are instances of a generic controller.

According to another aspect, a computer program product is provided including program code, when executed on a computer system, for providing an interface between a calling application and at least one callable application. The program code includes an interface architecture component. The interface architecture component comprises: an input/output module; an input parser; a universal state machine; a knowledge base module; a process slip module; a process carrier.

According to another aspect, a software-implemented method of interfacing a calling application and at least one callable application is provided. The method comprises: using at least two software-implemented controllers at different hierarchical levels; performing, with the controllers both at the higher and lower hierarchical levels, a sequence of steps comprising: upon receipt of an input request from a higher hierarchical level element (which is the calling application or a controller at a higher hierarchical level), performing input request handling, sending at least one output request to at least one lower hierarchical level element (which is a controller at a lower hierarchical level or the at least one callable application), receiving an input response to the at least one output request from the lower hierarchical level element, and sending an output response to the higher hierarchical level element. The output request of the controller at the higher hierarchical level is the input request to the controller at the lower hierarchical level, and the output response of the controller at the lower hierarchical level is the input response to the controller at the higher hierarchical level.

According to a another aspect, a method of implementing a programmed interface between a calling application and at least one callable application is provided. The method comprises: coding at least two controllers at different hierarchical levels, wherein said controllers are instances of a generic controller.

According to another aspect, a computer program product is provided including program code, when executed on a computer system, for providing an interface between a calling application and at least two transaction-tax calculation applications. The interface is arranged to carry out, when called by the calling application, at least one of: selecting one of the transaction-tax calculation applications depending on a transaction attribute, calling the selected transaction-tax calculation application and receiving a response from the called transaction-tax calculation application; and calling at least two of the transaction-tax calculation applications, comparing the responses returned by them.

According to still another aspect, a software-implemented method of interfacing a calling application and at least two transaction-tax calculation applications is provided. The method comprises, when a call is received from the calling application, at least one of: selecting one of the transaction-tax calculation applications depending on a transaction attribute, calling the selected transaction-tax calculation application and receiving a response from the called transaction-tax calculation application; and calling at least two of the transaction-tax calculation applications and comparing the responses returned by them.

### DESCRIPTION OF THE DRAWINGS

Embodiments of the invention will now be described, by way of example, and with reference to the accompanying drawings, in which:

FIG. 1 is a diagram illustrating the internal overall process flow in an embodiment of an interface;

FIG. 2 is a diagram illustrating an exemplary data flow between the calling and called applications and the interface and within the interface;

FIG. 3 is a high-level architecture diagram of an embodiment of the interface;

FIG. 4 illustrates an exemplary asynchronous logging procedure;

FIG. 5 shows a simplified class diagram of the embodiment of the interface in UML notation;

FIG. 6 is a high-level architecture diagram of an embodiment of a generic architecture component of the interface;

FIG. 7 illustrates an embodiment of a process flow in a solution controller;

FIG. 8 illustrates an embodiment of a process flow in a calculation controller;

FIG. 9 illustrates an embodiment of a process flow in a logging controller;

FIG. 10 is a flow diagram illustrating of an embodiment of a country-specific selection of a called tax calculation application;

FIG. 11 is a flow diagram illustrating an embodiment of a process in which more than one tax calculation application is called;

FIG. 12 illustrates another embodiment of an interface;

FIG. 13 shows a diagrammatic representation of a machine in exemplary form of a computer system within which a set of instructions, for causing the machine to perform any of the methodologies discussed herein, may be executed.

### DESCRIPTION OF THE PREFERRED EMBODIMENTS

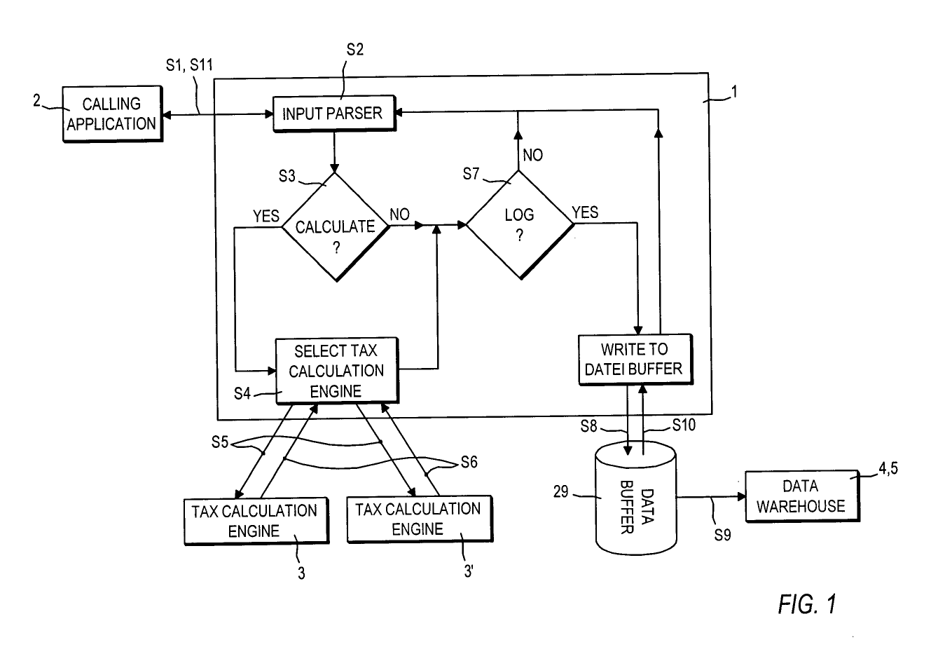

FIG. 1 illustrates the internal overall process flow in an embodiment of an interface. Before proceeding further with the description of FIG. 1, however, a few items of the embodiments will be discussed.

The preferred embodiments of the computer program product include any machine-readable medium that is capable of storing or encoding program code for execution by a computer system. The term “machine-readable medium” shall accordingly be taken to include, but not to be limited to, solid state memories, optical and magnetic storage media, and carrier wave signals. The program code may be machine code or another code which can be converted into machine code by compilation and/or interpretation, such as source code in a high-level programming language or virtual-machine code.

In some of the embodiments, general architecture components or “controllers” are functional components implemented by software. The hardware on which the software (or program code) is executed so as to provide the controllers may be a computer system, for example including a processor and a main memory which communicate with each other via a bus, as well as a disc drive unit, a network interface device and input/output units (such as a video display unit, an alpha-numeric input device and a cursor control device). The program code may be stored on the disc drive unit, within the main memory and/or the processor and may be transmitted or received via the network interface device. In some embodiments, the entire program code may be distributed over several processors or computers. For example, each controller may run on a distinct computer. An architecture use of at least two controllers inherently enables distributed processing. In other embodiments the program is integrated in a single computer.

In some of the embodiments, the interface coordinates the processing to be carried out in response to a call by the calling application. For example, the interface determines what sequence of steps is to be performed, based on “event type” information it receives as a parameter of the call. Thus, the calling application requires no knowledge of calling sequences for different event types. Accordingly, the interface decouples the calling application from the called applications and thereby also decouples the processes implemented by the called applications (which, for example represent business processes) from the processes implemented by the called application.

In some of the embodiments, at least two controllers are at different hierarchical levels. Since they co-operate with each other, the controller at the higher hierarchical level is superordinate to the controller at the lower hierarchical level. For example, the higher hierarchical level controller outputs requests or tasks which form an input to the lower hierarchical level controller. The lower hierarchical level controller follows such a request or task, e.g. by returning a response to the higher hierarchical level controller. However, in some of the embodiments with more than two controllers, not all of them are at different hierarchical levels. Rather, they may form a tree-like structure in which some of the controllers are at the same hierarchical level. For example, in an embodiment with three controllers, the higher hierarchical level controller may form the root of the tree and have two children, i.e. subordinate controllers, both on the same lower hierarchical level. In other embodiments there are more than two levels of controllers, i.e. at least one child controller has a grand-child controller.

In some of the embodiments, the computer program which implements the controllers has a replicative program structure. On the source code level, a particular controller is implemented on the basis of a generic program or program part defining a “generic controller”, which is adapted to the specific needs of a particular controller and thereby forms an “instance” of the generic controller. Thus, the interface of some embodiments with replicative structure is made up of a building block (the generic controller) which is reused so as to form the instances of at least two controllers co-operating with each other at the different hierarchical levels.

Such a replicative program structure in which the controllers are instances of a generic controller may be achieved in different traditional ways, for example, when coding the computer program of the interface, by copying program code representing the generic controller several times and adapting each copy so as to represent an instance of the generic controller, or by implementing the generic controller in the form of a generic function or procedure which is callable with a set of parameters which effectively adapt the generic controller so as to form an instance, and by calling this generic function or procedure with appropriate instance-related parameters. However, in other embodiments, another technique is used to generate the replicative program structure, which is based on the “inheritance” feature of object-oriented program languages (see, for example, Cay Horstmann: Computing Concepts with JAVA 2 Essentials, 2nd edition, John Wiley and sons, 1999, pp. 341 to 380). In some of these embodiments, the computer program is thus written in an object-oriented programming language (such as JAVA or C++), and the generic controller is a class, and the instances of the generic controller are subclasses inherited from the generic controller class. In the terminology of object-oriented programming, a class from which a subclass is inherited is also called the “superclass” of the subclass. Some object-oriented programming languages (such as C++) enable a subclass to have more than one superclass, which is known as multiple inheritance. Other object-oriented programming languages (such as JAVA) do not allow multiple inheritance, but retain most of its benefits by limiting all but one of the superclasses to a restricted form by using “interfaces” instead of superclasses. Methods in an interface are abstract; that is they have a name, parameters and a return type, but they do not have an implementation. In the present context the concept of “inheritance” is meant to also include such “interfaces” with abstract methods; however, in some of the preferred embodiments, “inheritance” is meant in the sense of inheritance from a superclass (i.e. the inherited methods are concrete; that is they have an implementation). As to “interfaces” in JAVA, see Horstmann, pp. 362-368.

In the description of the embodiment, the terms “program code” and “computer program” are used, and it is defined that the program code represents a computer program. This terminology is used since the program code included in the computer program product is typically (but not exclusively) machine code or virtual-machine code, whereas the computer program is typically (but not exclusively) written in a high-level programming language. Thus, the “program code” and the “computer program” are typically (but not necessarily) not identical, but the program code can be obtained from the computer program by compilation in a well-defined way, and therefore represents the computer program. Although the replicative structure with controllers (which are instances of a generic controller) is typically implemented by source code, i.e. at the level of the “computer program”, it will, at least to a certain extent, be mapped to the machine code i.e. to the “program code”, in the compilation procedure. Thus the replicative structure with co-operating controllers (which are instances of a generic controller) at different hierarchical levels will at least be partly present in the machine code.

In some of the embodiments with a replicative controller arrangement, this arrangement does not only show up as replicative structure in the computer program and the program code, but also as a replicative sequence of steps, since the process sequence carried out by the controllers is similar due to their common descent from the generic controller. The controllers at both the higher and lower hierarchical levels perform a sequence of steps in which a controller receives an (input) request from a superordinate element (which may be a calling application if the considered controller is the higher hierarchical controller, or an (output) request from the higher hierarchical controller if the considered controller is the lower hierarchical controller), and the input request is then handled. Then, optionally, depending on the results of the request handling, one or more output requests are sent to at least one lower hierarchical level element (which is a controller at a lower hierarchical level if the considered controller is a lower hierarchical controller, or a callable application, if the considered controller is a lower hierarchical controller). In reaction to the output request, an input response is then received from the lower hierarchical element, and, based thereon, an output response is sent to the upper hierarchical level element. The interaction between the controllers is such that the output request of the controller at the higher hierarchical level is the input request to the controller at the lower hierarchical level, and the output response of the controller at the lower hierarchical level is the input response to the controller at the higher hierarchical level.

Such a replicative program structure facilitates the implementation of an interface between a calling application and at one or more callable applications. Therefore, the described embodiments also disclose a method of implementing such an interface. The method includes coding at least two controllers at different hierarchical levels, wherein the controllers are instances of a generic controller, as explained above.

In some of the embodiments, a calling application may be a business application, such as a commercial-transaction application (wherein the “commercial transaction” may be, for example, the sale of goods or services) or an ERP application, in the framework of which a service provided by a callable application is required.

In some embodiments the calling application outputs a batch of calls to the callable application or applications. In those embodiments, the interface is arranged to receive and handle batches of service requests (“events”) from the calling application, and also to return responses batch-wise to the calling application. Since the interface processes the requests and calls one or more callable applications event by event, it is provided with buffers for incoming requests and outgoing responses. In other embodiments, the calling application sends requests separately, e.g. event by event. The first alternative is also called “offline processing”, and the second alternative “online processing”. A typical case of offline processing is a business application which processes a batch of events, without human intervention between individual events. Offline processing usually requires high machine capacities since typically large batches of events have to be processed within relatively short time. Online processing is carried out if machine calls are issued on an event-by-event basis, or if the process is user-driven, in the sense that each individual event is triggered by a user's intervention. Business applications may require online processing (for example, if a service is immediately required during a sale transaction) or offline processing (for example, when a report has to be prepared which summarizes information from a large number of transactions). In other embodiments, the calling application is an online request handling application, such as a Web server. The user (or another application) can send a request for a service provided by the callable application or applications via a network (i.e. the Internet) to the online request handling application, which forwards the request to the interface.

In some of the embodiments, the callable application or applications are transaction-tax service applications or include a transaction-tax service application. One of the transaction tax services provided in the preferred embodiments is transaction tax calculation, another one is transaction tax logging. Therefore, in the described embodiments at least one of the transaction-tax service applications coupled to the interface is a transaction-tax calculation application and/or a transaction-tax logging application. The transaction-tax calculation and transaction-tax logging applications are also called transaction tax calculation and transaction tax logging “engines” hereinafter.

When the calling application sends a call to the interface, it generally sends, along with the call, an attribute or attributes to the interface which enable the application then called by the interface to provide the required service. The attribute may be data (i.e. in the form of a document) or a pointer to stored data which is assessable by the interface or the called application. In embodiments in which the called application is a transaction-tax service application, the attribute data of a call (which refers to a particular commercial transaction) may include an indication of the price paid in the transaction, the nature of the transaction, the place and time of the transaction and the persons or entities involved in the transaction.

A transaction-tax calculation engine calculates the amount of transaction tax to be paid for a given transaction. In principle, it would be sufficient to couple the interface to only one transaction-tax calculation engine, if this engine enabled the transaction taxes for all transactions occurring in a particular context to be correctly calculated. However, a worldwide coverage of transactions of all different types is at least presently hardly achievable in a satisfactory way by means of only one transaction-tax calculation engine, since the available transaction-tax calculation engines tend to lay the emphasis on particular countries or regions and/or particular transaction types. Therefore, in some embodiments, two or more transaction-tax calculation engines may be called by the interface.

In some of the embodiments with more than one transaction-tax calculation engine, when the interface is called by the calling application, it selects one of the transaction-tax calculation engines depending on transaction data received with the call. For example, if the transaction is a sale of goods in the U.S. or EU (European Union) (which is indicated by a corresponding country code included in the transaction data) the interface selects the transaction-tax calculation engine from those available which enables the transaction tax to be correctly calculated for a sale in the U.S. or EU, respectively. The interface then calls the selected transaction-tax calculation engine and receives the calculated transaction tax as a response from it.

In other embodiments with more than one transaction-tax calculation engine, the interface does not select and call only one transaction-tax calculation engine for a given transaction, but rather calls more than one transaction-tax calculation engine for the given transaction, and correspondingly receives more than one response. The interface then compares and handles these responses, preferably according to rules which can be implemented by a user. For exampie, the interface may ascertain that the tax amounts provided by the two (or more) called transaction-tax calculation engines are equal, but in the event that they are not equal, it may select the response which indicates the lowest tax amount.

In some embodiments, both of the above-described alternatives are combined. For example, the interface may be coupled to a set of four transaction-tax calculation engines which has two subsets, each with two engines for tax calculation in the U.S. or the EU, respectively. In such an embodiment the interface selects for a given transaction one of the two subsets, then calls the two transaction-tax calculation engines of the selected subset, and compares the results returned by them.

Another transaction-tax service application called by the interface of some of the embodiments is a transaction-tax logging application. Most legal systems require transaction data of tax-relevant transactions to be recorded or “logged” on a transaction-by-transaction basis. In addition to such legal reporting requirements, big enterprises often have internal financial reporting needs for tax optimization on a global basis. The logging application of these embodiments includes or is coupled to a database or a data warehouse (see short explanation of “Data warehouses” in D. Messerschmitt: Understanding networked applications, Morgan Kaufmann Publishers 2000, pp. 83-84). Usually, data can only be entered asynchronously into a data warehouse. Therefore, in some of the embodiments that use a data warehouse, data output by the interface in order to be logged are first put on a data buffer from where they are fetched in an asynchronous manner by the logging application and stored in the data warehouse. The decision of whether a logging has to take place and what has to be logged (the data to be logged is also called the “logging payload”) is taken by the interface. On the basis of this decision, the interface constructs the logging payload and outputs it to the logging application. In most of the embodiments, it is sufficient to use only one logging application. However, in certain other embodiments it may be desirable to couple the interface to two or more logging applications, e.g. to one logging application for legal reporting and another one for internal financial reporting.

For some transactions only a transaction-tax calculation application is called (or more than one transaction-tax calculation engine), for other transactions first a transaction-tax calculation application and then the logging application is called. There may be still other transactions, “logging only” transactions, in which no tax calculation is required and only the logging application is called (for example, if the amount of transaction tax is already known or is not required for certain transactions). In some of the embodiments, the controller at the higher hierarchical level is arranged for controlling the overall sequence of steps carried out by the interface. This controller is also called “solution controller”. It decides whether and in which sequence the controllers at the lower hierarchical level are invoked. In embodiments also having lower hierarchical level controllers, it is, however, not responsible for the control of calls to the callable applications (e.g. the transaction-tax service applications) coupled to the interface. Rather, the controller or controllers at the lower hierarchical level (which are called “calculation controller” and “logging controller” in the transaction tax-related embodiment) are arranged to control process steps which are specific to the callable application or applications with which the respective lower hierarchical level controller is associated. Such callable-application-specific processing includes, for example, deciding with the calculation controller which one of two or more country-specific transaction-tax calculation engines are to be called for a given transaction. Another, simpler example is just calling a callable application and supplying the output data to it, e.g. done by the logging controller with the logging payload.

From a point of view of process steps, the controller at the higher hierarchical level receives an input request from the calling application and sends an output request to the controller at the lower hierarchical level. The controller at the lower hierarchical level receives the output request of the controller at the higher hierarchical level, now considered as an “input request”, and sends an output request to the callable application or to one or more of the callable applications with which it is associated. In turn, it receives an input response from the called application or applications, and sends an output response to the controller at the higher hierarchical level. The controller at the higher hierarchical level receives this output response (now called “input response”). In some of the embodiments in which the controllers are instances of a generic controller, the instances of the controllers comprise one or more of the following components: an input-output module, and input parser, a validation engine, a universal state machine, a knowledge base module, a process slip module, and a process carrier. The input-output module provides an interface to other controllers or calling or callable applications. The input parser extracts information from the incoming data flow. The validation engine performs a validity check according to the service called, the state in the universal state machine and the data provided with the call. The knowledge base module keeps the information about the order of the process steps to be carried out and may also store high-level service information. The process slip module keeps track of the different process steps that a request has already passed. Besides keeping this information, the process slip module may provide a resolution between externally used identifiers and one unique identifier for the present call, i.e. it acts as an identification reference unit. The process carrier keeps requestrelated input and output data while the processing is not yet completed. The universal state machine coordinates the internal processing flow. It accesses the knowledge base module and the process slip module, and determines the next process step according to the internal state and guarantees a successful completion of the respective data in the process carrier by invoking the appropriate actions.

In some embodiments the interface does not have several cooperating controllers at different hierarchical levels which are instances of generic controller. Some of these embodiments, however, use an interface architecture component similar to the controllers described above, which includes an input/output module, an input parser, a universal state machine, a knowledge base module, a process slip module, and a process carrier. In some of these embodiments it further includes a validation engine for ascertaining the validity of calls received by the interface.

Other embodiments of the interface without several controllers at different hierarchical levels which are instances of a generic controller are associated with at least two transaction-tax calculation engines and are arranged to select one of the transaction-tax calculation applications depending on the attribute data, which is, for example, received along with a call from the calling application. The interface sends a call to the selected transaction-tax calculation engine and, thereupon, receives a response from it. In other embodiments two or more transaction-tax calculation engines are called for one and the same event, and the responses return by them are compared.

As has already been described above, selecting a suitable transaction-tax calculation engine and/or calling more than one transaction-tax calculation engine and comparing the returned responses may advantageously (but not necessarily) be combined with interfaces having controllers at different hierarchical levels and/or with one interface architectural component as described above.

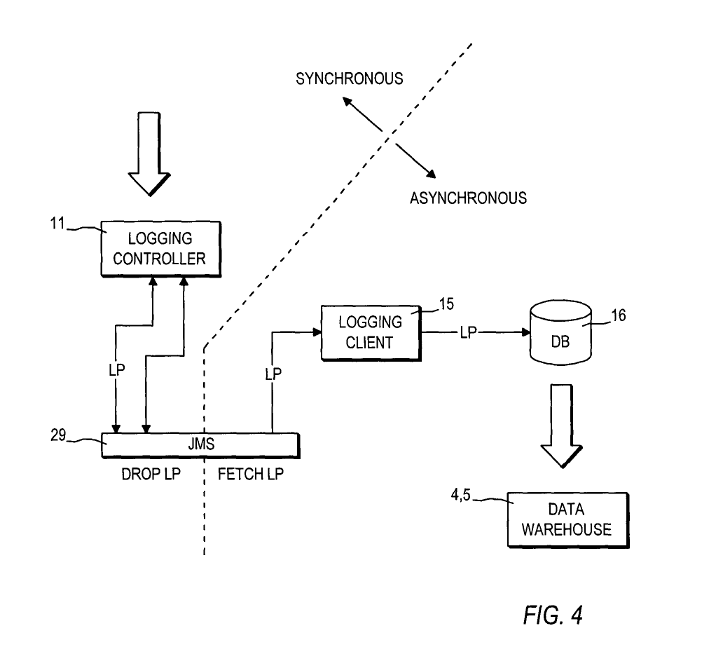

Returning now to FIG. 1, it illustrates the internal overall process flow in an interface 1. The interface 1 receives in step S1 a request for a transaction tax service (an “event”) from a calling application 2 (which is for example a business application or an online request handling application). In step S2, an input parser extracts information from the incoming data flow associated with the request (also called “interface request payload”). In step S3 it is ascertained whether a transaction tax calculation is to be carried out for the present service request. The answer depends on the particular event: for example, if the call from the calling application or the data attached to it indicates that no calculation, but only logging is to be carried out or if the data does not allow tax calculation, the answer in step S3 is negative. If, however, the answer is positive, then in step S4 a tax calculation engine which is appropriate for the present event is selected from at least two available tax calculation engines 3, 3′. In step S5, a transaction-tax calculation request is sent to the selected tax calculation engine 3 or 3′, together with data required for the transaction tax calculation (also called “calculation payload”). When the response from the called tax calculation engine is received together with the calculation result data (also called “calculation result payload”) in step S6, it is ascertained in step S7 whether logging has to be performed for the present event. Step S7 is also carried out if the answer in step S3 is negative (i.e. if no tax calculation is to be carried out). If the answer in step S7 is positive, logging data (also called “logging payload”) is written to a data buffer 29 in step S8, from where it is asynchronously fetched and stored in a data warehouse 5 in step S9. The data warehouse 5 embodies the transaction-tax logging application 4, and the data buffer 29 is an adapter, as is explained in more detail in the context of FIG. 4. If the logging payload has successfully been written to the data buffer 29 in step S8, the valid logging of the present event is indicated, e.g. by a valid logging flag (also called “valid logging indication”), in step S10, and a response with output data (also called “interface response payload”) is returned to the calling application 2 in step S11. The interface response payload includes the calculated tax amount and the valid logging indication. If the answer in step S7 is negative, i.e. no logging is carried out, a response is directly sent to the calling application after the tax calculation in steps S3 to S6; the interface response payload includes the calculated tax amount, but no valid logging indication.

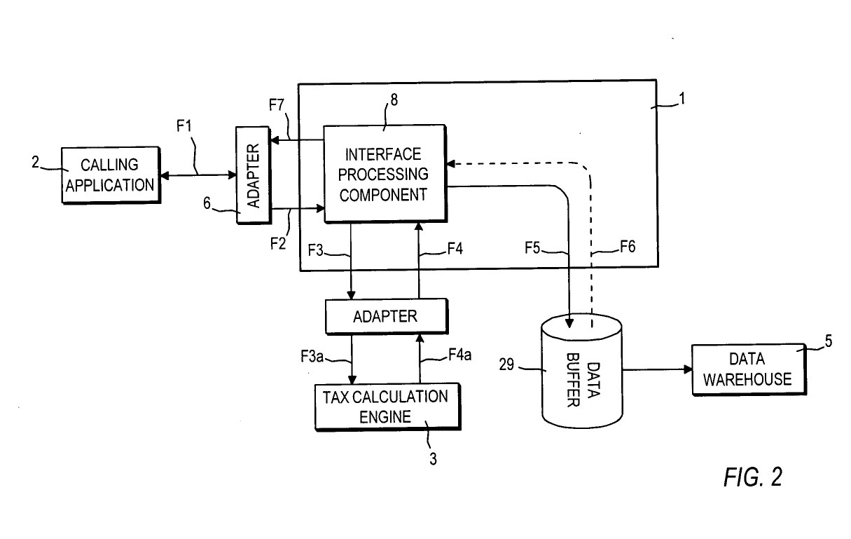

FIG. 2 illustrates the data flow between the calling and called applications and the interface and within the interface. A generic data model is used within the interface 1. In some of the embodiments, data is internally transferred in the form of XML documents. XML Schemas define what data elements are mandatory or optional. The internal data streams are transmitted within the interface 1 using HTTP. The calling and called applications may send and receive data payloads according to other, application-specific data models and may use other transfer protocols than the one used within the interface 1. Adapters 6, 7 between the external applications and the interface 1 convert the data streams from the internal data model to the external data model(s) and vice versa and/or the internal transfer protocol to the external transfer protocol(s) and vice versa. In some of the embodiments (but not necessarily), the data transferred through the interface is transaction tax-related data which represents transaction-related information required for calculating the transaction tax for the present transaction and/or for complying with reporting requirements of tax authorities and internal reporting needs. This generally includes data identifying the participants of the transaction, the kind of transaction, the country or countries in which the transaction took/takes place, the price paid/to be paid in the transaction, etc.

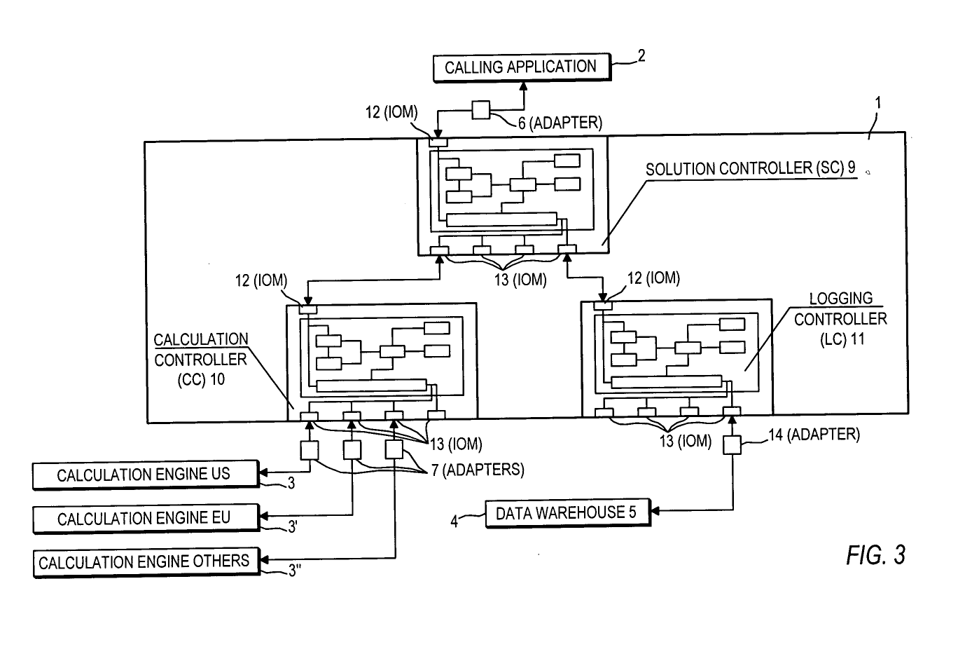

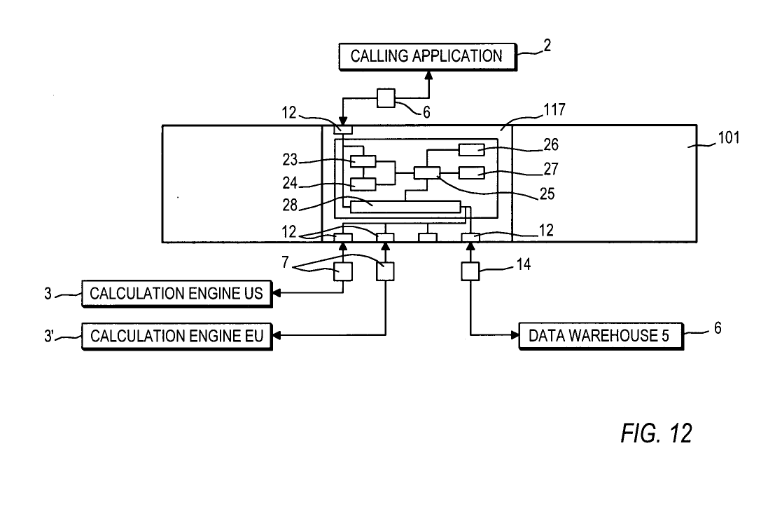

In FIG. 2, when the calling application 2, e.g. a business application (such as SAP-SD), sends a request, e.g. a transaction tax calculation and/or logging request, to the interface 1 for a particular transaction. An interface request payload, e.g. transaction tax-related data for this transaction, is transferred together with the request to the interface 1. The data flow of the interface request payload is indicated by “F1” in FIG. 2. The data flow F1 is based on a data model and/or a transfer protocol specific and typically proprietary to the calling application 2. The adapter 6 between the calling application 2 and an interface processing component 8 transforms the incoming data flow F1 into a data flow F2 based on the internally used generic data model and transfer protocol. (The interface processing component 8, for example, corresponds to the assembly of controllers 9, 10 and 11 of FIG. 3 or the architecture component 117 of FIG. 12.) The interface processing component 8 processes the interface request payload F2 so as to provide a subset of it (here the “calculation payload”). The subset includes that data which is relevant for the application to be called, here the transaction tax engine 3. The calculation payload F3 is sent together with a calculation request to tax calculation engine 3. The adapter 7 transforms the calculation payload F3 according to a data model and/or transfer protocol specific and typically proprietary to the calculation application 3. The transformed calculation payload is called “F3a”. The tax calculation engine 3 may be a Web service, a service provided within an intranet, or a service provided within the same computer in which the calling application 2 is running. Together with the subsequent response of the calculation engine 3, the calculation result payload F4a which includes the result of the tax calculation is returned to the interface 1, again based on the specific data model and/or transfer protocol of the calculation application 3. The adapter 7 transforms it into a calculation result payload F4 based on the interface's generic internal data format. The interface processing component 8 processes the data flow F4 so as to comply with requirements of the calling application 2, and sends the result, called interface response payload F7, to the adapter 6 which converts it to the data model and/or transfer protocol of the calling application 2, and forwards it to the calling application 2 as data flow F1. If logging is required, the interface processing component 8 combines the interface request payload F2 from the calling application 2 with the calculation result payload F4 from the calculation application 3 and sends the resulting data flow, the logging payload F5, to the data buffer 29, from where it is asynchronously fetched and stored in the data warehouse 5. In some embodiments, a valid logging indication is returned to the interface processing component 8 (data flow F6) if the logging payload has successfully been deposited in the data buffer 29. The data buffer 29 is an adapter between the interface processing component 8 and the warehouse 5. The embodiment shown in FIG. 2 has only one tax calculation engine, but in other embodiments with more than one tax calculation engine the data flows correspond to the ones described in connection with FIG. 2.

FIG. 3 is a high-level diagram of a preferred embodiment of an interface 1 that has a replicative structure. It is based on a generic architecture component, also referred to as “generic controller”. Several instances of the generic controller (also referred to as “controllers”) are arranged at different hierarchical levels. In the example of FIG. 3, there are three controllers at two different hierarchical levels. A controller called solution controller 9 is arranged at the higher hierarchical level, and two controllers, called calculation controller 10 and logging controller 11 are arranged at a lower hierarchical level. The controllers 9, 10, 11 are cascaded (or arranged in a tree-like structure), and controllers at different hierarchical levels co-operate with each other.

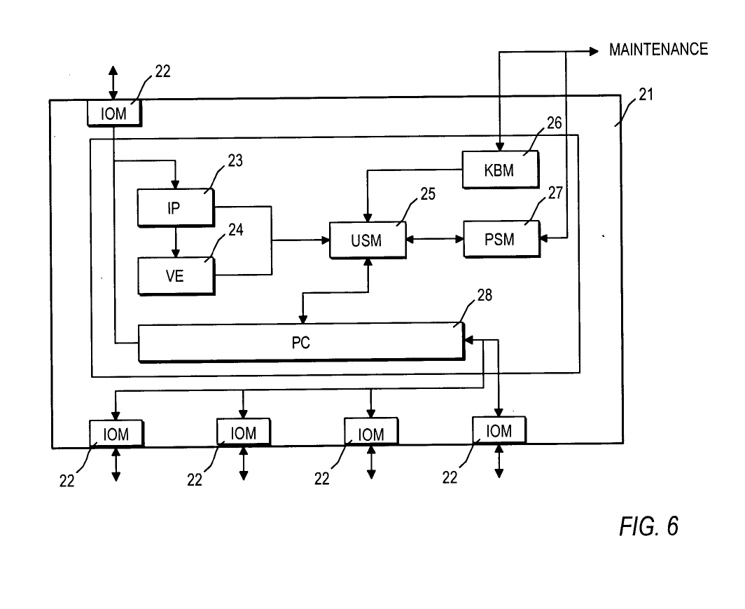

In some of the embodiments, the controllers 9, 10, 11 each have only one (upper) entry point 12 for their request/response processing, which is an upper input/output module (see FIG. 6—“IOM”). In addition, they may have one or more further entry points constituting a user interface, e.g. for simulation, set-up, tests, maintenance, etc. The controllers 9, 10, 11 also have one or more (lower) exit points 13, which are lower input/output modules 13 (see FIG. 6—“IOM”), one for each lower hierarchical level controller 10, 11 or callable application 3, 4, respectively.

The solution controller 9 is arranged to process a request, e.g. transaction-tax service request received from the calling application 2 via the adapter 6 and the entry point 12. It decides on the basis of the request and/or the data associated with it whether the calculation controller 10 or the logging controller 11 or both are to be called, and, if the latter case applies, in what sequence they are to be called, and performs the call(s) via the respective exit point 13. It also forms subsets of and combines data, as was explained with reference to FIG. 2.

On the lower hierarchical level, one controller is provided for each type of service, i.e. a calculation controller 10 and a logging controller 11. They communicate with the superordinate solution controller 9 via their respective entry points 12. The task of the lower hierarchical level controllers 10, 11 is to process a call of the solution controller 9 and to forward a suitable call to a service application 3, 4 via one of their exit points and adapters 7, 14. If more than one service application 3, 3′ can be called by a controller, as is the case with calculation controller 10, the controller also decides which one of the service applications 3, 3′ is to be called. For example, in the case of transaction tax calculation, the decision may be taken on the basis of the country to which the present transaction relates. The calculation controller 10 receives the responses from the called service applications 3, 3′ via the corresponding exit point 13 and processes and forwards them to the solution controller 9. In embodiments in which more than one service application 3, 3′ may be called for one and the same transaction, the calculation controller 10 also compares the results returned from the called service applications 3, 3′, consolidates the two or more results (e.g. by choosing the one which indicates the lowest transaction tax) and forwards the consolidated result to the solution controller 9.

When the logging controller 11 is called by the solution controller 9, it forwards a corresponding logging request together with the data to be logged, the logging payload, to the data warehouse 5 via its exit point 13 and a logging adapter 14, which is explained in more detail in FIG. 4. Typically, no response data is returned from the data warehouse 5 or adapter 14, except a valid logging indication. Correspondingly, the logging controller 12 does not return any response data to the solution controller 9 except for a valid logging indication.

The solution controller 9 processes the responses and response data returned from the calculation controller 10 and/or logging controller 11 and returns a corresponding response to the calling application 2 via the entry point 12 and adapter 6.

Turning now to FIG. 4, since data logging in a persistent storage is a performance-heavy process, typical data warehouses (such as the “SAP Business Warehouse”) do not enable synchronous (“online”) logging. On the other hand, some embodiments of the interface 1 require logging requests to be processed as they appear, i.e. synchronously. FIG. 4 illustrates an embodiment of an adapter 14 (FIG. 3) and the logging process by which a bridging between the interface's synchronous and the data warehouse's asynchronous environments is provided. The logging controller 11 sends a logging request together with the logging payload (“LP” in FIG. 4) to an adapter (referred to as “adapter 14” in FIG. 3) composed of a data buffer 29, an asynchronous logging client 15 and a data base 16. The logging payload—which is e.g. in the form of an XML document—is synchronously dropped in the data buffer 29. The asynchronous logging client 15 fetches the logging payload from the data buffer 29 in an asynchronous way. Thus, the data buffer 29 and the client 15 represent a bridge between the synchronous and asynchronous environments. The control of this bridge and communication across the bridge may be based on a message service, such as the Java Message Service (JMS). The client 15 forwards the fetched data to the database 16 from where it is entered or fetched into the data warehouse 5. The message service is configured to ensure that no transaction data sent for logging gets lost. In some embodiments, a valid logging indication is (synchronously) returned to the logging controller 11 when the logging payload has successfully been deposited in the data buffer 5.

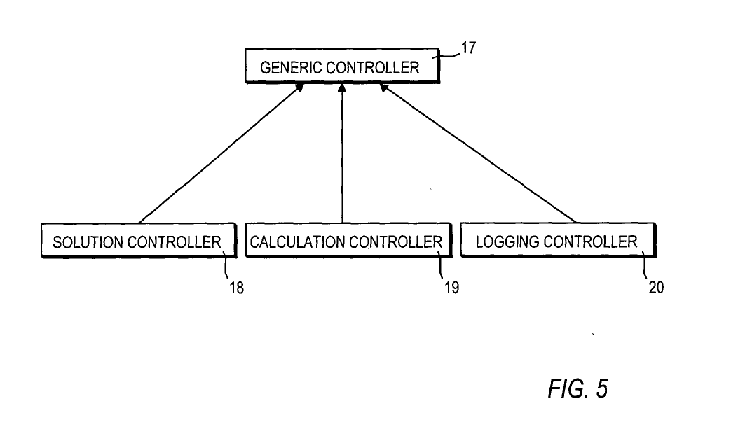

FIG. 5 shows a simplified class diagram of the interface 1 in UML (Unified Modeling Language) notation. The boxes shown represent classes implemented in an object-oriented programming language. A GenericController class 17 is a superclass of the other classes shown in FIG. 5. Three subclasses of the GenericController class 17 are the SolutionController class 18, CalculationController class 19 and LoggingController class 20. They implement the solution controller 9, calculation controller 10 and logging controller 11 of FIG. 3. There is an inheritance relationship between the superclass 17 and the subclasses 18, 19, 20, i.e. the subclass 18, 19, 20 inherit from the superclass 17. In the JAVA programming language, the inheritance relationship is, for example, defined by the keyword “extends”. Inheritance enables code to be reused: by inheriting from the superclass 17, methods and variables defined in it are available in the subclasses 18, 19, 20. The subclasses 18, 19, 20 may use these methods and variables inherited from the superclass 17 and can further be adapted to their specific needs by defining special subclass methods and variables and by overriding inherited superclass methods. Thus, in the perspective of the superclass, properties common to the subclasses 18, 19, 20 are collected in the generic controller superclass 17.

FIG. 6 is a high-level architecture diagram of the generic architecture component or “generic controller” 21 represented by the GenericController class 17 in FIG. 5. The solution controller 9, calculation controller 10 and logging controller 11 of FIG. 3 are instances of the generic controller 21.

The generic controller is composed of the following functional components: Several input/output modules 22 (IOM), an input parser 23 (IP), a validation engine 24 (VE), a universal state machine 25 (USM), a knowledge base module 26 (KBM), a process slip module 27 (PSM), and a process carrier 28 (PC).

The input/output modules 22 provide interfaces to calling or called applications or to other controllers. The embodiment of the generic controller 21 shown in FIG. 6 has one upper input/output module 22 and several lower input/output modules 22, since in many embodiments only one upper entry point is provided, but several lower exit points, in order to enable more than one application 3, 4 or controller 18, 19, 20 to be called. In other embodiments with more than one upper entry point, a corresponding number of upstream input/output modules 22 are provided. If in an instance of the generic controller 21 only one application has to be called (as is the case with the logging controller 11 in FIG. 3), only one lower input/output module 22 is instantiated. The input/output modules 22 are bidirectional. They pass calls (i.e. requests) and responses along with call or response attributes, which are, for example, contained in a document (e.g. an XML document) attached to the call or response. In some of the embodiments, the input/output module 22 may be arranged to support both online flow and batch flow. To this end it is provided with a bi-directional online interface, an input buffer for the input batch flow and an output buffer for the output batch flow. An input/output module 22 with this functionality may preferably be instantiated as the upper input/output module 22 of the solution controller 9 which is the interface's entry point for calling applications 2.

The input parser 23 extracts information from the incoming data flow, the interface request payload, e.g. in the form of an XML-document attached to the call. The definition of what information is extracted may depend on the called service. For example, if the called service is “tax calculation” other information may be extracted than if the called service is “logging”.

The validation engine 24 subsequently performs a validity check of the extracted information, which may again depend on the called service, and, in addition, on the data provided and the present state of the universal state machine 25. For example, a validity check may ascertain whether a called service is available and whether the call to the service is complete and consistent. When the generic controller 21 is instantiated, validation is particularly useful in the upper hierarchical level controller, e.g. the solution controller 9, but can also be performed in the lower hierarchical level controllers, e.g. the solution and calculation controllers 10, 11. However, if performance is critical, the validation engine 24 can be inactivated or omitted in the upper hierarchical level controller 9 and in particular in the lower hierarchical level controllers 10, 11, since the latter only receive internal calls from the superordinate higher hierarchical level controller 9.

The knowledge base module 26 keeps (i.e. stores) the information about the individual process steps to be performed and the order in which they are to be performed within the controller 9, 10, 11. Upon request of the process slip module 27, it returns information characterizing a particular process step to be carried out to the universal state machine 25. The knowledge base module 26 also stores high-level service information.

The process slip module 27 keeps information about the different process steps. This information is put down into the process slip assigned to the current process (event) in the beginning of the process. The process slip includes all alternative process paths to enable the universal state machine 25 to carry out the correct logical sequence. The process slip is restricted to the hierarchical layer of its controller 9, 10; 11. The process slip is comparable to a statetransition diagram. The process slip module 27 keeps track of the different process steps that a processing request has already passed and determines which process steps are still to be performed in the current process., It requests the knowledge base module 26 to return the required process step information to the universal state machine 25. Optionally, the process slip module 27 also defines a case-dependent data model, i.e. a sub-model of the full data model, wherein the sub-model definition may depend on the event type, on the specific application to be called, etc. According to the sub-model definition, only a sub-set of the whole data set may be attached to a request or response. Furthermore, the process slip module 27 provides a resolution between externally used identifiers and one unique identifier used internally for each event, e.g. each transaction. Such a unique event identification enables “interleaved” processing. This means that processing of a new event can start before the processing of the previous transaction event has been completed, i.e. before a response from the tax calculation application 3 has been received for the previous event. Preferably, for each event a new thread or process is started, and the event identification then identifies the thread or process assigned to a particular event.

The process carrier 28 keeps (i.e. stores) the input and output data associated with an event while the processing of the event is not yet completed.

The universal state machine 25 coordinates the internal process flow. It accesses the knowledge base module 26 and the process slip module 27 and thereby determines the next process step according to the present internal state. This guarantees successful completion of the respective task and the data in the process carrier 28 by invoking the appropriate steps and actions.

In addition to the entry point at the upper input/output module 22, the generic controller 21 provides another entry point constituting a user interface, e.g. for simulation, set-up, tests, manual intervention, maintenance, in particular maintenance of the knowledge, processes and the rules stored in the knowledge base module 26, etc.

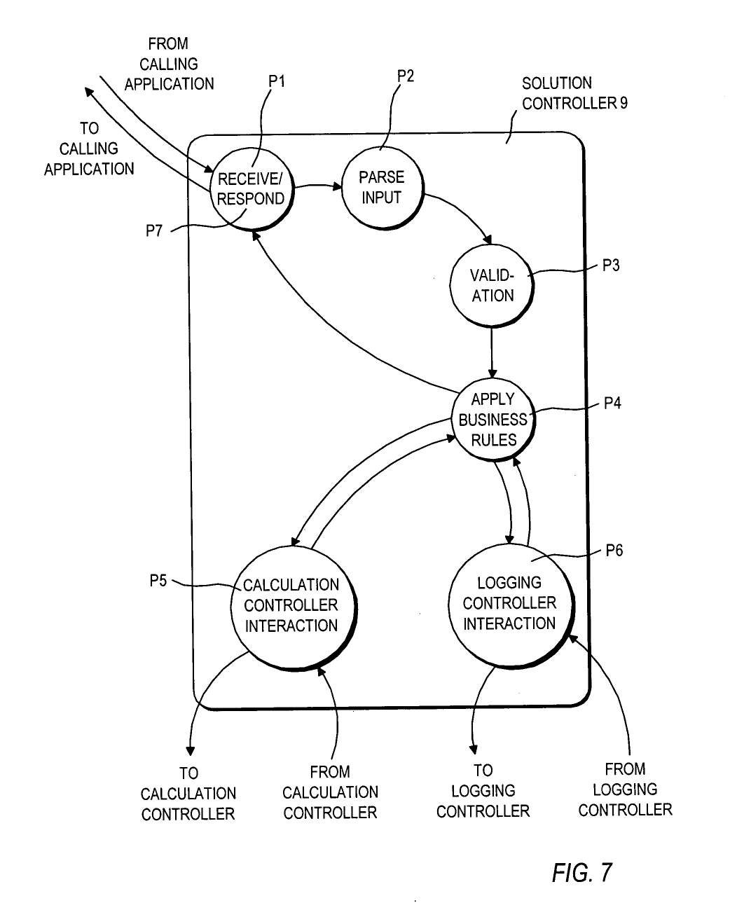

Due to the above-described replicative program structure, not only the structure of the instances 9, 10, 11 of the generic controller 21, but also the processes carried out by them are similar to each other. This is illustrated by FIGS. 7 to 9, which show the process flow within the solution controller 9, calculation controller 10 and logging controller 11.

In the solution controller process flow according to FIG. 7, a call from the calling application 2 is received by the input/output module 22 and forwarded to the input parser 23 (e.g. an XML parser), which parses the input data in step P1. The parsed information is then validated by the validation engine 24 in step P2. In step P3, the universal state machine 25 processes the event on the basis of “business rules” which define the overall processing carried out by the solution controller 9. For example, in an embodiment, a first business rule has the following form:

| | | | Exception? |
|---|---|---|---|
| | | | (=evaluate |
| | Calculation | Logging | second |
| Event type | required? | required? | business rule?) |
| Trade order | yes | no | yes |
| generation | | | |
| Final trade invoice | yes | yes | no |
| generation | | | |
| . . . | . . . | . . . | . . . |

The first business rule shown in the table above requires transaction tax calculation to be performed, i.e. the calculation controller 10 be called for both event types that are expressly mentioned in the table. However, logging is only required, i.e. the logging controller 11 is only called, for the event type “Final trade invoice generation”, but is not required for the event type “Trade order generation”. However, in the case of a “Trade order generation” event an “Exception” flag is set, which means that a second business rule is evaluated. By contrast, for the other event type, “Final trade invoice generation”, the exception flag is not set, i.e. for those events of that type the second business rule is not evaluated. There may be other event types for which logging is only required (“logging only” transactions).

An example of the second business rule is:

| Transaction event type | Country |
|---|---|
| Trade order generation | ES |
| . . . | . . . |

According to the above second business rule, if the “Country” of the transaction is “ES” (Spain) then the solution controller 9 mandates logging also for “Trade order generation” events, although for this event type logging is generally not triggered, according to the first business rule.

Further business rules may, for example, perform a conditional check of the existence of data elements in the input file (e.g. an XML file), if, for example, some input data elements are optional for some event types but mandatory for others, and the input file validation (e.g. XML-input-file validation) is not capable of performing conditional validation.

Depending on the event type and the business rules, the universal state machine 25 initiates a call to the calculation controller 10 in step P5. Upon receipt of the calculation controller's 10 response, and depending on the event type and the business rules, the universal state machine 25 then either returns the response to the calling application 2 via the input/output module 12 in step P5, or calls the logging controller 11 in step P6. For “logging only” events the logging controller 6 is only called. The logging controller 6 returns a confirmation that the logging has been successfully completed (a valid logging indication), whereupon the result included in the calculation controller's 10 response and, optionally, a valid logging indication are returned to the calling application in step P7.

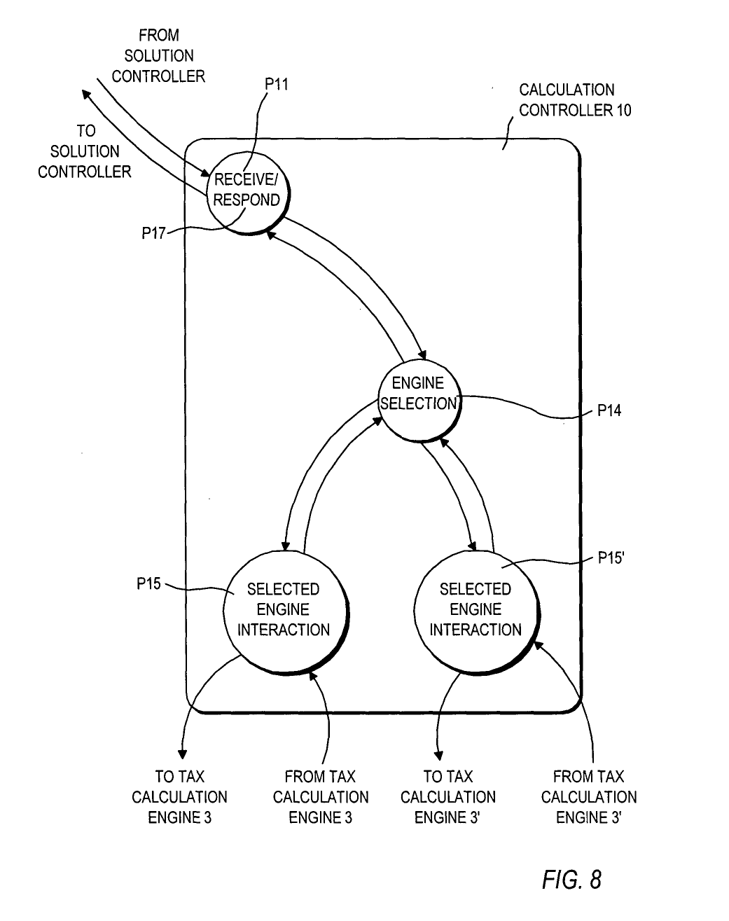

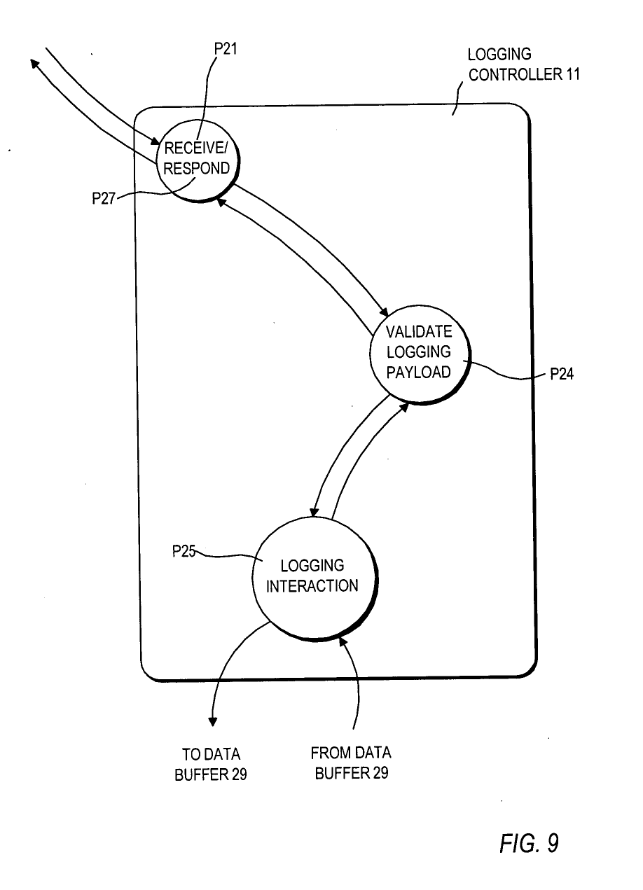

FIG. 8 illustrates the process flow in the calculation controller 10. A call from the superordinate solution controller 9 is received by the input/output module 12 in step P 11 and is then directly processed by the universal state machine 25 in step P14. An optional intermediate validation step is omitted in the embodiment shown in FIG. 8 since the calculation controller 10 is only internally called by the superordinate solution controller 9—the same applies to the process flow of the logging controller 11 shown in FIG. 9. In the processing step P14, mainly one of several tax calculation engines 3, 3′ is selected by selection rules. For example, a certain tax calculation application 3, 3′ may be assigned to one or more certain transaction countries. For a particular event with a particular transaction country indicated by the calculation request payload, the tax calculation engine assigned to the particular transaction country is selected from engines 3, 3′. The selected tax calculation application 3, 3′ is then called in step P15, P15′. The response received from it is returned to the solution controller 9 via the input/output module 12 in step P17.

FIG. 9 illustrates the process flow in the logging controller 11. A call from the superordinate solution controller 9 is received by the input/output module 12 in step P21 and is then directly processed by the universal state machine 25 in step P24. The processing includes, for example, validating the data to be logged (the logging payload) on the basis of logging-related rules. Such a validation step is preferably included in the logging controller's processing in order to still ascertain in the “synchronous region” whether all data elements mandatory for logging are present. If such a validation were instead performed in the “asynchronous region” it would be difficult to signalize the absence of a mandatory data element. In principle, the logging validation may also be performed by the solution controller 9, which is a possible, but more complex solution. Thereupon, a logging request is sent to the logging data buffer 29 in step P25. A confirmation that the logging has been successfully completed is returned to the logging controller 11 and forwarded to the calling solution controller 9 via the input/output module 21 in step P27.

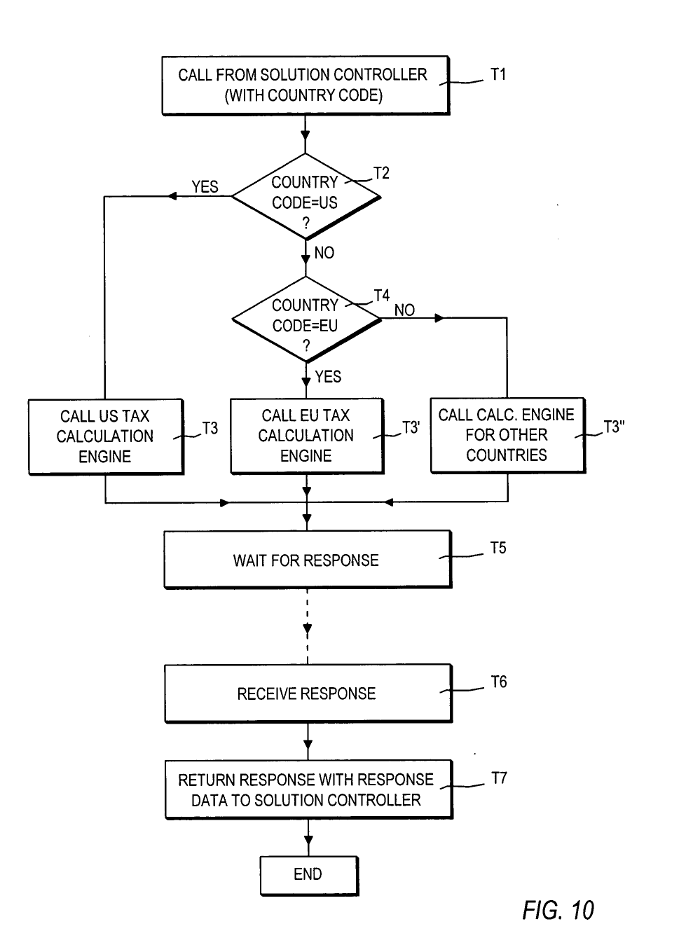

FIG. 10 is a flow diagram illustrating an embodiment of a country-specific selection of a tax calculation engine 3. In the embodiment of FIG. 10, the interface 1 is enabled to send tax calculation requests to three different tax calculation engines: a U.S. tax calculation engine 3, an EU tax calculation engine 3′ and a tax calculation engine 3″ for other countries. In embodiments with a dedicated calculation controller 10 (such as the ones described in connection with FIGS. 3 to 9), country-specific selection is performed by the calculation controller 10. In step T1, it receives a call from the superordinate solution controller 9 together with the interface request payload which includes data characterizing the current event to be processed, in particular including a country code of the country relevant for the event. In step T2 it is ascertained whether the country code is “US”. If the answer in step T2 is positive, the U.S. tax calculation engine 3 is called in step T3. The call is accompanied by data required for the tax calculation (the calculation request payload). If, however, the answer in step T2 is negative, it is ascertained in step T4 whether the country code is “EU”. If the answer is positive, the EU tax calculation engine 3′ is called in step T3′. If, however, the answer in step T4 is negative, the tax calculation engine 3″ is called in step T3″. In step T5, the calculation controller 10 waits for a response from the called calculation engine 3, 3′ or 3″. When the response is received in step T6 together with result data (the calculation response payload), the calculation controller 10 returns a response to the calling application controller 9 together with response data (the interface response payload) in step T7.

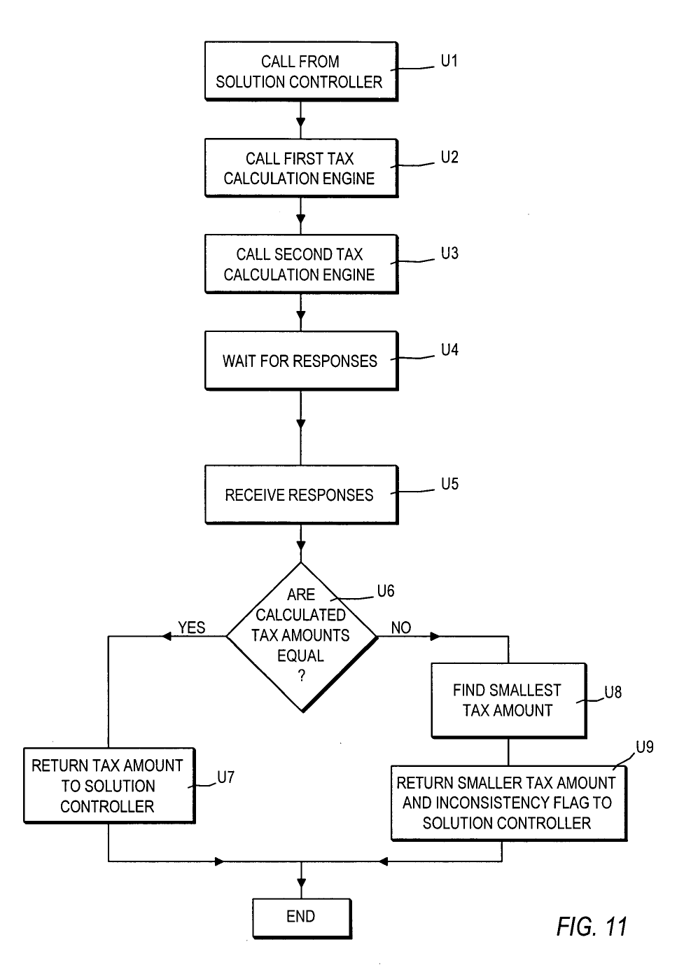

FIG. 11 is a flow diagram of another embodiment in which more than one tax calculation are called (here referred to as first tax calculation engine 3 and second tax calculation engine 3′) for one and the same event, also referred to as “redundant tax calculation”. In embodiments with a dedicated calculation controller 10, as the ones of FIGS. 3 to 8, the process illustrated in FIG. 11 is carried out by the calculation controller 10. It receives a call from the superordinate solution controller 9 in step U1. In step U2, it calls the first tax calculation engine 3 as well as the second tax calculation engine 3′, in step U3. In step U4, it waits for the responses of the called tax calculation engines 3, 3′. When the responses are received in step U5, the calculation controller 10 compares in step U6 the received results, e.g. it ascertains whether the tax amounts calculated by the called tax calculation engines 3, 3′ are equal. If the answer is positive, the calculated tax amount is returned in step U7 as a response to the request in step U1 to the superordinate solution controller 9. If the answer is negative, the smaller of the tax amounts received from the called tax calculation applications 3, 3′ is determined in step U8. In step U9, it is returned as a response to the call in step U1 to the solution controller 9. In the latter case, in some embodiments an inconsistency flag is set in the response data so as to notify the calling solution controller 9 that an inconsistency has been discovered in the redundant tax calculation controlled by the calculation controller 10. The inconsistency flag can, for example, be used for testing and debugging purposes.

FIG. 12 illustrates another embodiment of an interface 101 without a replicative structure. The interface 101 receives a call from a calling business application 2, sends a request to tax calculation engines 3 and/or 3′, combines the result(s) received from it (them) with data received from the calling business application 2 and logs the combined data in a data buffer of an adapter 14 to a data warehouse 5, or returns the result(s) from the calculation engines 3 and/or 3′ to the calling business application 2, in a similar way as was explained in connection with the replicative embodiments described in connection with FIGS. 3 to 9. The external functionality of interface 101 is thus the same as the one of the replicative interface in FIGS. 3 to 9, in particular the functionality regarding the country-specific selection of a tax calculation engine illustrated in FIG. 10 and/or the functionality of calling more than one tax calculation engine, as illustrated in FIG. 11. Internally, the interface 101 has no replicative controller structure, but, in some embodiments, has one interface architecture component 117 which resembles the generic controller 17 of FIG. 5. In contrast to the solution controller 9 of FIG. 3, the interface architecture component 117 is also responsible for the selection of one of the calculation engines 3, 3′, the consistency check if both tax calculation applications 3, 3′ are called during one transaction event, and the data verification before the logging is carried out. Correspondingly, all the business rules described in connection with FIGS. 7 to 9 which are distributed over the replicative embodiments over the different controllers 9 to 11, are now combined in the architecture component controller 117.

The interface 101 need not be used for interfacing transaction tax-related applications. Rather, it may be used as an interface between calling on callable applications of any other type or for any other purpose.

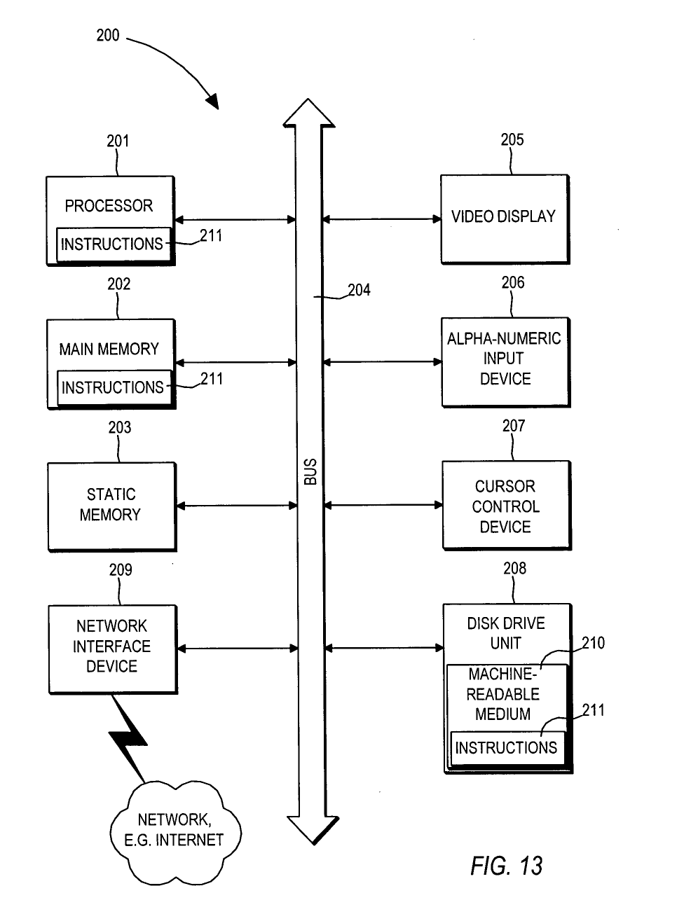

FIG. 13 shows a diagrammatic representation of a machine in exemplary form of a computer system 200 within which a set of instructions, for causing the machine to perform any of the methodologies discussed herein, may be executed. The computer system 200 includes a processor 201 and memory. In the example of FIG. 13 it is a main memory 202 and a static memory 203, which communicate with each other via a bus 204. The computer system 200 may include further optional components, such as a video display unit 205, an alpha-numeric input device 206, a cursor control device 207, a disk drive unit 208 and a network interface device 209.

Further optional components are a disk drive unit 208 which includes a machine-readable medium 210 on which is stored a set of instructions (i.e. software) 211 embodying any one, or all, of the methodologies described above. The software 211 is also shown to reside, completely, or at least partially, within the main memory 202 and/or within the processor 201. The software 211 may further be transmitted or received via the network interface device 209. In other embodiments, the software 211 is distributed over several processors or computers. For example, each controller may run on a distinct computer.

Thus, embodiments of interfaces having a replicative structure, embodiments with an architecture component, and embodiments enabling an appropriate transaction-tax calculation engine to be selected or to call more than one calculation engine for one and the same event to be called have been described.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. A computer program product including program code, when executed on a computer system, for providing an interface between a calling application and at least one callable application, said program code representing a computer program which implements at least two controllers which cooperate with each other and are at different hierarchical levels, wherein said controllers are instances of a generic controller.

2. The computer program product of claim 1, wherein the computer program is written in an object-oriented programming language, and the generic controller is a class, and the at least two controllers are subclasses inherited from the generic controller class.

3. The computer program product of claim 1, wherein the calling application is a computerized business application or an online request handling application.

4. The computer program product of claim 1, wherein the at least one callable application is a transaction-tax service application.

5. The computer program product of claim 4, wherein the at least one transaction-tax service application is a transaction-tax calculation application or a transaction-tax logging application.

6. The computer program product of claim 4, providing an interface to at least two transaction-tax service applications, said transaction-tax service applications comprising at least two different transaction-tax calculation applications.

7. The computer program product of claim 1, wherein the controller at the higher hierarchical level is arranged for controlling an overall logic processing of the interface, and the controller or controllers at the lower hierarchical level is or are arranged for controlling a processing of the interface specific to the callable application or applications with which the respective controller is associated.

8. The computer program product of claim 7, wherein
the controller at the higher hierarchical level is arranged for receiving an input request from the calling application and sending an output request to the controller at the lower hierarchical level, and receiving an output response from the controller at the lower hierarchical level as an input response,
the controller at the lower hierarchical level is arranged for receiving the output request of the controller at the higher hierarchical level as an input request, sending an output request to the callable application or one or more of the callable applications to which it is associated, receiving an input response from the callable application or applications, and sending an output response to the controller at the higher hierarchical level.

9. The computer program product of claim 8, providing an interface to at least two callable applications of a same type, wherein the specific processing for which the controller at the lower hierarchical level and assigned to the at least two callable applications is arranged comprises deciding to which one of the at least two callable applications the output request is sent.

10. The computer program product of claim 9, wherein the at least two callable applications of the same type are transaction-tax calculation applications.

11. The computer program product of claim 1, wherein the controllers comprise at least one of the following components:
an input/output module;
an input parser;
a validation engine;
a universal state machine;
a knowledge base module;
a process slip module;
a process carrier.

12. A computer program product including program code, when executed on a computer system, for providing an interface between a calling application and at least one callable application, said program code including an interface architecture component, comprising:
an input/output module;
an input parser;
a universal state machine;
a knowledge base module;
a process slip module;
a process carrier.

13. The computer program product of claim 12, wherein said interface architecture component further comprises a validation engine.

14. The computer program product of claim 12, wherein said interface comprises at least two cascaded interface architecture components.

15. A software-implemented method of interfacing a calling application and at least one callable application, comprising:
using at least two software-implemented controllers at different hierarchical levels;
performing, both with the controllers at the higher and lower hierarchical levels, a sequence of steps comprising:
upon receipt of an input request from an higher hierarchical level element, which is the calling application or a controller at a higher hierarchical level, performing input request handling,
sending at least one output request to at least one lower hierarchical level element, which is a controller at a lower hierarchical level or the at least one callable application,
receiving an input response to the at least one output request from the lower hierarchical level element,
sending an output response to the higher hierarchical level element,
wherein the output request of the controller at the higher hierarchical level is the input request to the controller at the lower hierarchical level, and the output response of the controller at the lower hierarchical level is the input response to the controller at the higher hierarchical level.

16. The method of claim 15, wherein the at least one callable application is a transaction-tax service application.

17. The method of claim 15, wherein the at least one transaction-tax service application is a transaction-tax calculation application or a transaction-tax logging application.

18. A method of implementing a programmed interface between a calling application and at least one callable application, comprising:
coding at least two controllers at different hierarchical levels, wherein said controllers are instances of a generic controller.

19. The method of claim 18, wherein the controllers are coded in an object-oriented programming language, and the generic controller is a class, and the at least two controllers are subclasses inherited from the generic controller class.

20. The method of claim 18, wherein the at least one callable application is a transaction-tax service application.

21. The method of claim 20, wherein the at least one transaction-tax service application is a transaction-tax calculation application or a transaction-tax logging application.

22. The method of claim 18, wherein the controller at the higher hierarchical level is arranged for controlling an overall logic processing of the interface, and the controller or controllers at the lower hierarchical level is or are arranged for controlling a processing of the interface specific to the callable application or applications with which the respective controller is associated.

23. The method of claim 22, wherein
the controller at the higher hierarchical level is arranged for receiving an input request from the calling application and sending an output request to the controller at the lower hierarchical level, and receiving an output response from the controller at the lower hierarchical level as an input response,
the controller at the lower hierarchical level is arranged for receiving the output request of the controller at the higher hierarchical level as an input request, sending an output request to the callable application or one or more of the callable applications to which it is associated, receiving an input response from the callable application or applications, and sending an output response to the controller at the higher hierarchical level.

24. The method of claim 23, wherein the interface is arranged to provide an interface to at least two callable applications of a same type, wherein the specific processing for which the controller at the lower hierarchical level and assigned to the at least two callable applications is arranged comprises deciding to which one of the at least two callable applications the output request is sent.

25. The method of claim 24, wherein the at least two callable applications of the same type are transaction-tax calculation applications.

26. The method of claim 18, wherein the controllers are implemented so as to comprise at least one of the following components:
an input/output module;
an input parser;
a validation engine;
a universal state machine;
a knowledge base module;
a process slip module;
a process carrier.

27. A computer program product including program code, when executed on a computer system, for providing an interface between a calling application and at least two transaction-tax calculation applications,
said interface is arranged to carry out, when called by the calling application, at least one of:
selecting one of the transaction-tax calculation applications depending on a transaction attribute, calling the selected transaction-tax calculation application and receiving a response from the called transaction-tax calculation application; and
calling at least two of the transaction-tax calculation applications, comparing the responses returned by them.

28. The computer program product of claim 27, wherein the interface is further arranged to return a response to the calling application based on the response from the called transaction-tax calculation application or, if at least two transaction-tax calculation applications have been called, based on the comparison.

29. The computer program product of claim 27, wherein the interface is further arranged to direct a response for logging purposes to a logging controller based on the response from the called transaction-tax calculation application or, if at least two transaction-tax calculation applications have been called, based on the comparison.

30. A software-implemented method of interfacing a calling application and at least two transaction-tax calculation applications,
comprising, when a call is received from the calling application, at least one of:
selecting one of the transaction-tax calculation applications depending on a transaction attribute, calling the selected transaction-tax calculation application and receiving a response from the called transaction-tax calculation application; and
calling at least two of the transaction-tax calculation applications and comparing the responses returned by them.
